(19) United States
(12) Patent Application Publication
(10) Pub. No.: US 2020/0294148 A1
(43) Pub. Date: Sep. 17, 2020

(54) ANALYSIS SYSTEMS AND METHODS

(71) Applicant: Baton Systems, Inc., Fremont, CA (US)

(72) Inventors: Arjun Jayaram, Fremont, CA (US); Saurabh Srivastava, San Ramon, CA (US); Mohammad Taha Abidi, San Ramon, CA (US)

(21) Appl. No.: 16/816,057

(22) Filed: Mar. 11, 2020

Related U.S. Application Data
(60) Provisional application No. 62/816,830, filed on Mar. 11, 2019.

(51) Int. Cl. G06Q 40/06

(52) U.S. Cl. CPC G06Q 40/06

(57) ABSTRACT

Example analysis systems and methods are described. In one implementation, a system identifies a financial goal to be achieved and identifies financial account information associated with the financial goal. A plurality of insights are generated based on information from a plurality of data sources. A tool is implemented to generate at least one action based on the financial goal, the account information, and the insights. The system generates a recommendation based on the plurality of insights and the action, and automatically implements the recommendation to accomplish the financial goal.

### RELATED APPLICATIONS

This application claims the priority benefit of U.S. Provisional Application Ser. No. 62/816,830, entitled “Data Platform,” filed on Mar. 11, 2019, the disclosure of which is hereby incorporated by reference herein in its entirety.

### TECHNICAL FIELD

The present disclosure relates to processing systems and, more particularly, to systems and methods that perform various analysis, operations, procedures and activities related to various tasks, actions and the like performed by one or more entities, individuals or parties.

### BACKGROUND

Individuals and groups in an organization typically have multiple goals to achieve. These goals may be related to a larger company-wide goal, but are more specific as the levels of responsibilities vary throughout the organization. For example, a business leader may have business goals of increasing the organization's ROE (Return On Equity) by a specific percentage, while the accounting team may have a more refined version of the goal (e.g., to reduce the annual pre-funding or use of cash. Additionally, members of the operational team may have a further refined goal to reduce the average daily time of over funding or funding with cash from 12 hours to nine hours.

Achieving company-wide goals typically requires individuals and teams to take specific actions, such as decision-making actions, operational actions, and the like. In some situations, it is desirable to provide insights and other information to assist the individuals and teams in taking particular actions.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 is a block diagram illustrating an environment within which an example embodiment may be implemented.

FIG. 2 is a block diagram illustrating an embodiment of a financial management system configured to communicate with multiple other systems.

FIG. 3 illustrates an embodiment of an example asset transfer between two financial institutions.

FIG. 4 illustrates an embodiment of a method for transferring assets between two financial institutions.

FIG. 5 illustrates an embodiment of a method for authenticating a client and validating a transaction.

FIG. 6 is a block diagram illustrating an embodiment of a financial management system interacting with an API server and an audit server.

FIG. 7 illustrates an embodiment of a process for achieving goals by making decisions and taking actions.

FIG. 8 illustrates an embodiment of a process that uses both operational insights and on-demand insights to identify one or more actions.

FIG. 9 illustrates an embodiment of a process for achieving goals or other tasks based on various decisions, actions, and the like.

FIG. 10 illustrates an example implementation of identifying specific data and other information.

FIGS. 11A-11C illustrate an example process of identifying specific data and other information.

FIG. 12 illustrates another example implementation of identifying specific data and other information.

FIGS. 13A and 13B illustrate another example process of identifying specific data and other information.

FIG. 14 illustrates an example state diagram showing various states that a transaction may pass through.

FIG. 15 is a block diagram illustrating an embodiment of a financial management system interacting with a cryptographic service and multiple client nodes.

FIG. 16 illustrates an embodiment of an analysis management system.

FIG. 17 is a block diagram illustrating an example computing device.

### DETAILED DESCRIPTION

It will be readily understood that the components of the present systems and methods, as generally described and illustrated in the figures herein, could be arranged and designed in a wide variety of different configurations. The following detailed description of the embodiments of the activity management systems and methods is not intended to limit the scope of the invention, as claimed, but is merely representative of certain examples of presently contemplated embodiments in accordance with the invention.

Existing financial institutions typically maintain account information and asset transfer details in a ledger at the financial institution. The ledgers at different financial institutions do not communicate with one another and often use different data storage formats or protocols. Thus, each financial institution can only access its own ledger and cannot see data in another financial institution's ledger, even if the two financial institutions implemented a common asset transfer.

The systems and methods described herein enable institutions to move assets on demand by enabling authorized users to execute complex workflows. Additionally, the described systems and methods allow one or more 3rd parties to view payment activities between participants. Further, the systems and methods support a notary service that uses time stamps and other information to authenticate (or verify) data associated with all parties (e.g., principals) of a transaction, such as a financial transaction.

As used herein, a workflow describes, for example, the sequence of activities associated with a particular transaction, such as an asset transfer. In particular, the systems and methods provide a clearing and settlement gateway between, for example, multiple financial institutions. When a workflow is executed, the system generates and issues clearing and settlement messages (or instructions) to facilitate the movement of assets. A shared permissioned ledger (discussed herein) keeps track of the asset movement and provides visibility to the principals and observers in substantially real time. The integrity of these systems and methods is important because the systems are dealing with core payments that are a critical part of banking operations. Additionally, many asset movements are final and irreversible. Therefore, the authenticity of the request and the accuracy of the instructions are crucial. Further, reconciliation of transactions between multiple parties are important to the management of financial data.

As discussed herein, payments between parties can be performed using multiple asset types, including currencies, treasuries, securities (e.g., notes, bonds, bills, and equities), and the like. Payments can be made for different reasons, such as margin movements, collateral pledging, swaps, delivery, fees, liquidation proceeds, and the like. As discussed herein, each payment may be associated with one or more metadata.

As used herein, DCC refers to a direct clearing client or an individual or institution that owes an obligation. A payee refers to an individual or institution that is owed an obligation. A CCG (or Guarantor) refers to a client clearing guarantor or an institution that guarantees the payment of an obligation. A CCP refers to a central counterparty clearinghouse and a Client is a customer of the FCM (Futures Clearing Merchant)/CCG guarantor. Collateral settlements refer to non-cash based assets that are cleared and settled between CCP, FCM/CCG guarantor, and DCC. CSW refers to collateral substitution workflow, which is a workflow used for the pledging and recall (including substitution) of collateral for cash. A clearing group refers to a logical grouping of stakeholders who are members of that clearing group that are involved in the clearing and settlement of one or more asset types. A workflow, when executed, facilitates a sequence of clearing and settlement instructions between members of a clearing group as specified by the workflow parameters.

When some financial transactions change state (e.g., initiated-pending-approved-cleared-settled, etc.) it may trigger one or more notifications to the principals involved in the transaction. The systems and methods described herein provide multiple ways to receive and respond to these notifications. In some embodiments, these notifications can be viewed and acknowledged using a dashboard associated with the described systems and methods or using one or more APIs.

As used herein, principals refer to the parties that are directly involved in a payment or transaction origination or termination. An observer refers to a party that is not a principal, but may be a stakeholder in a transaction. In some embodiments, an observer can subscribe for a subset of notifications generated by the systems and methods discussed herein. In some situations, one or more principals may need to agree that the observer can receive the subset of notifications. APIs refer to an application program interface that allow other systems and devices to integrate with the systems and methods described herein.

Specific examples discussed herein refer to a financial management system communicating with various systems, financial institutions, authorized systems/devices, data stores, and the like. Although particular examples are discussed with respect to transferring and settling funds between two financial institutions, the same systems and methods may facilitate or manage financial transactions between multiple parties associated with a trade finance situation. For example, the financial management system and methods discussed herein may perform various operations and procedures related to trade finance between two or more entities, individuals, or parties. In some embodiments, the trade finance may be associated with a transaction between a seller and a buyer of goods or services, a transaction between an exporter and an importer, and the like.

The systems and methods described herein use a distributed permissioned ledger (also referred to as a “permissioned ledger”) and smart workflows/contracts in a supply chain and trade finance process to enable real time visibility across multiple participants. With the use of the permissioned ledger, participants only have access to their own data. However, lineage and reconciliation of the whole trade can be achieved by using the distributed permissioned ledger.

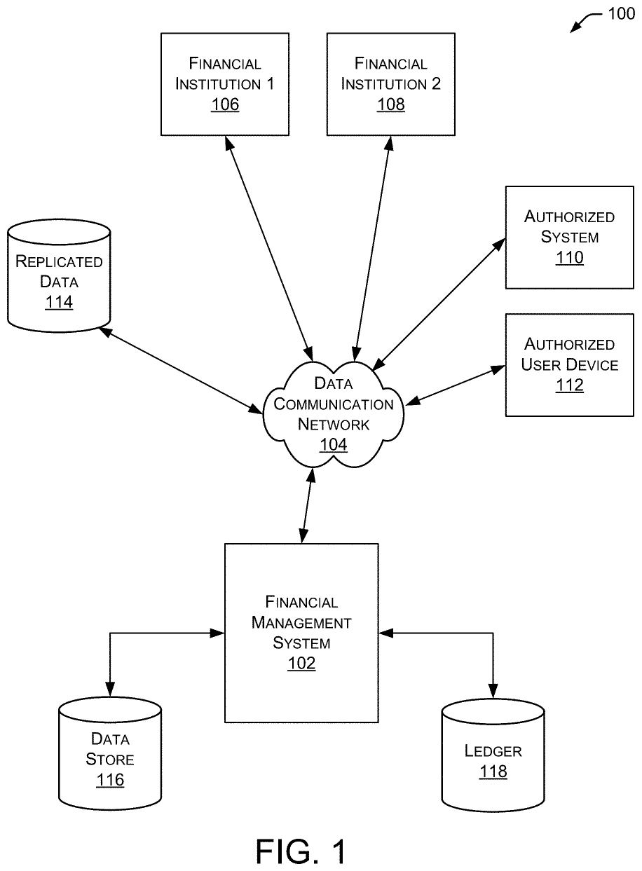

FIG. 1 is a block diagram illustrating an environment 100 within which an example embodiment may be implemented. A financial management system 102 is coupled to a data communication network 104 and communicates with one or more other systems, such as financial institutions 106, 108, an authorized system 110, an authorized user device 112, and a replicated data store 114. As discussed in greater detail herein, financial management system 102 performs a variety of operations, such as facilitating the transfer of assets between multiple financial institutions or other entities, systems, or devices. Although many asset transfers include the use of a central bank to clear and settle the funds, the central bank is not shown in FIG. 1. A central bank provides financial services for a country's government and commercial banking system. In the United States, the central bank is the Federal Reserve Bank. In some implementations, financial management system 102 provides an on-demand gateway integrated into the heterogeneous core ledgers of financial institutions (e.g., banks) to view funds and clear and settle all asset classes. Additionally, financial management system 102 may efficiently settle funds using existing services such as FedWire.

In some embodiments, data communication network 104 includes any type of network, such as a local area network, a wide area network, the Internet, a cellular communication network, or any combination of two or more communication networks. The described systems and methods can use any communication protocol supported by a financial institution's ledger and other systems. For example, the communication protocol may include SWIFT MT (Society for Worldwide Interbank Financial Telecommunication Message Type) messages (such as MT 2XX, 5XX, 9XX), ISO 20022 (a standard for electronic data interchange between financial institutions), and proprietary application interfaces exposed by particular financial institutions. Financial institutions 106, 108 include banks, exchanges, hedge funds, and any other type of financial entity or system. In some embodiments, financial management system 102 interacts with financial institutions 106, 108 using existing APIs and other protocols already being used by financial institutions 106, 108, thereby allowing financial management system 102 to interact with existing financial institutions without significant modification to the financial institution's systems. Authorized system 110 and authorized user device 112 include any type of system, device, or component that is authorized to communicate with financial management system 102. Replicated data store 114 stores any type of data accessible by any number of systems and devices, such as the systems and devices described herein. In some embodiments, replicated data store 114 stores immutable and auditable forms of transaction data between financial institutions. The immutable data cannot be deleted or modified. In particular implementations, replicated data store 114 is an append only data store which keeps track of all intermediate states of the transactions. Additional metadata may be stored along with the transaction data for referencing information available in external systems. In specific embodiments, replicated data store 114 may be contained within a financial institution or other system.

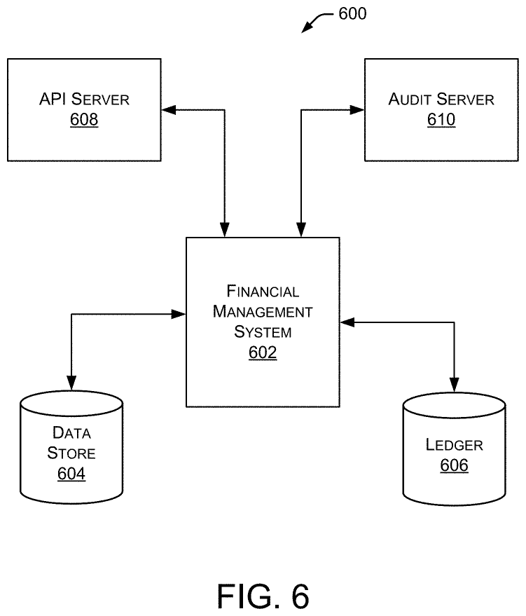

As shown in FIG. 1, financial management system 102 is also coupled to a data store 116 and a ledger 118. In some embodiments, data store 116 is configured to store data used during the operation of financial management system 102. Ledger 118 stores data associated with multiple financial transactions, such as asset transfers between two financial institutions. As discussed herein, ledger 118 is constructed in a manner that tracks when a transaction was initiated and who initiated the transaction. Thus, ledger 118 can track all transactions and generate an audit trail, as discussed herein. Using an audit server of the type described with respect to FIG. 6, financial management system 102 can support audit trails from both the financial management system and external systems and devices. In some embodiments, each transaction entry in ledger 118 records a client identifier, a hash of the transaction, an initiator of the transaction, and a time of the transaction. This data is useful in auditing the transaction data.

In some embodiments, ledger 118 is modeled after double-entry accounting systems where each transaction has two entries (i.e., one entry for each of the principals to the transaction). The entries in ledger 118 include data related to the principal parties to the transaction, a transaction date, a transaction amount, a transaction state, any relevant workflow reference, a transaction ID, and any additional metadata to associate the transactions with one or more external systems. The entries in ledger 118 also include cryptographic hashes to provide tamper resistance and auditability. Users for each of the principals to the transaction only have access to their own entries (i.e., the transactions to which the principal was a party). Access to the entries in ledger 118 can be further restricted or controlled based on a user's role or a party's role, where certain data is only available to certain roles.

In some embodiments, ledger 118 is a shared ledger that can be accessed by multiple financial institutions and other systems and devices. In particular implementations, both parties to a specific transaction can access all details related to that transaction stored in ledger 118. All details related to the transaction include, for example, the parties involved in the transaction, the type of transaction, the date and time of the transaction, the amount of the transaction, and other data associated with the transaction. Additionally, ledger 118 restricts permission to access specific transaction details based on relevant trades associated with a particular party. For example, if a specific party (such as a financial institution or other entity) requests access to data in ledger 118, that party can only access (or view) data associated with transactions to which the party was involved. Thus, a specific party cannot see data associated with transactions that are associated with other parties and do not include the specific party.

The shared permission aspects of ledger 118 provides for a subset of the ledger data to be replicated at various client nodes and other systems. The financial management systems and methods discussed herein allow selective replication of data. Thus, principals, financial institutions, and other entities do not have to hold data for transactions to which they were not a party.

It will be appreciated that the embodiment of FIG. 1 is given by way of example only. Other embodiments may include fewer or additional components without departing from the scope of the disclosure. Additionally, illustrated components may be combined or included within other components without limitation. In some embodiments, financial management system 102 may also be referred to as a “financial management platform,” “financial transaction system,” “financial transaction platform,” “asset management system,” or “asset management platform.”

In some embodiments, financial management system 102 interacts with authorized systems and authorized users. The authorized set of systems and users often reside outside the jurisdiction of financial management system 102. Typically, interactions with these systems and users are performed via secured channels. To ensure the integrity of financial management system 102, various constructs are used to provide system/platform integrity as well as data integrity.

In some embodiments, system/platform integrity is provided by using authorized (e.g., whitelisted) machines and devices, and verifying the identity of each machine using security certificates, cryptographic keys, and the like. In certain implementations, particular API access points are determined to ensure that a specific communication originates from a known enterprise or system. Additionally, the systems and methods described herein maintain a set of authorized users and roles, which may include actual users, systems, devices, or applications that are authorized to interact with financial management system 102. System/platform integrity is also provided through the use of secure channels to communicate between financial management system 102 and external systems. In some embodiments, communication between financial management system 102 and external systems is performed using highly secure TLS (Transport Layer Security) with well-established handshakes between financial management system 102 and the external systems. Particular implementations may use dedicated virtual private clouds (VPCs) for communication between financial management system 102 and any external systems. Dedicated VPCs offer clients the ability to set up their own security and rules for accessing financial management system 102. In some situations, an external system or user may use the DirectConnect network service for better service-level agreements and security.

In some embodiments financial management system 102 allows each client to configure and leverage their own authentication systems. This allows clients to set their custom policies on user identity verification (including 2FA (two factor authentication)) and account verification. An authentication layer in file management system 102 delegates requests to client systems and allows the financial management system to communicate with multiple client authentication mechanisms.

Financial management system 102 also supports role-based access control of workflows and the actions associated with workflows. Example workflows may include Payment vs Payment (PVP) and Delivery vs Payment (DVP) workflows. In some embodiments, users can customize a workflow to add their own custom steps to integrate with external systems that can trigger a change in transaction state or associate them with manual steps. Additionally, system developers can develop custom workflows to support new business processes. In particular implementations, some of the actions performed by a workflow can be manual approvals, a SWIFT message request/response, scheduled or time-based actions, and the like. In some embodiments, roles can be assigned to particular users and access control lists can be applied to roles. An access control list controls access to actions and operations on entities within a network. This approach provides a hierarchical way of assigning privileges to users. A set of roles also includes roles related to replication of data, which allows financial management system 102 to identify what data can be replicated and who is the authorized user to be receiving the data at an external system.

In some embodiments, financial management system 102 detects and records all client metadata, which creates an audit trail for the client metadata. Additionally, one or more rules identify anomalies which may trigger a manual intervention by a user or principal to resolve the issue. Example anomalies include system request patterns that are not expected, such as a high number of failed login attempts, password resets, invalid certificates, volume of requests, excessive timeouts, http errors, and the like. Anomalies may also include data request patterns that are not expected, such as first time use of an account number, significantly larger than normal amount of payments being requested, attempts to move funds from an account just added, and the like. When an anomaly is triggered, financial management system 102 is capable of taking a set of actions. The set of actions may initially be limited to pausing the action, notifying the principals of the anomaly, and only resuming activity upon approval from a principal.

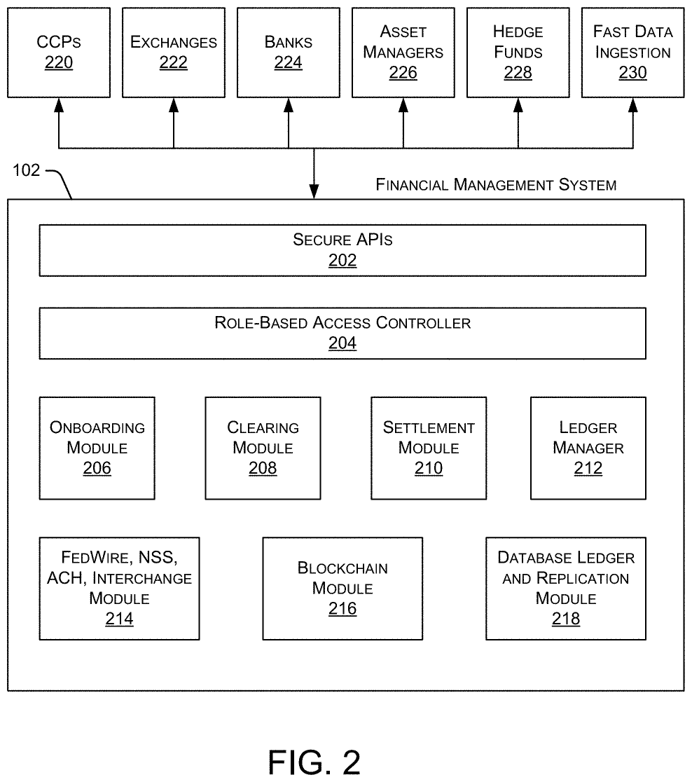

FIG. 2 is a block diagram illustrating an embodiment of financial management system 102 configured to communicate with multiple other systems. As shown in FIG. 2, financial management system 102 may be configured to communicate with one or more CCPs (Central Counterpart Clearing Houses) 220, one or more exchanges 222, one or more banks 224, one or more asset managers 226, one or more hedge funds 228, and one or more fast data ingestion systems (or “pipes”) 230. CCPs 220 are organizations that facilitate trading in various financial markets. Exchanges 222 are marketplaces in which securities, commodities, derivatives, and other financial instruments are traded. Banks 224 include any type of bank, credit union, savings and loan, or other financial institution. Asset managers 226 include asset management organizations, asset management systems, and the like. In addition to hedge funds 228, financial management system 102 may also be configured to communicate with other types of funds, such as mutual funds. Financial management system 102 may communicate with CCPs 220, exchanges 222, banks 224, asset managers 226, and hedge funds 228 using any type of communication network and any communication protocol. Fast data ingestion systems 230 include at least one data ingestion platform that consumes trades in real-time along with associated events and related metadata. The platform is a high throughput pipe which provides an ability to ingest trade data in multiple formats. The trade data are normalized to a canonical format, which is used by downstream engines like matching, netting, real-time counts, and liquidity projections and optimizers. The platform also provides access to information in real-time to different parties of the trade.

Financial management system 102 includes secure APIs 202 that are used by partners to securely communicate with financial management system 102. In some embodiments, the APIs are stateless to allow for automatic scaling and load balancing. Role-based access controller 204 provide access to modules, data and activities based on the roles of an individual user or participant interacting with financial management system 102. In some embodiments, users belong to roles that are given permissions to perform certain actions. An API request may be checked against the role to determine whether the user has proper permissions to perform an action. An onboarding module 206 includes all of the metadata associated with a particular financial institution, such as bank account information, user information, roles, permissions, clearing groups, assets, and supported workflows. A clearing module 208 includes, for example, a service that provides the functionality to transfer assets between accounts within a financial institution. A settlement module 210 monitors and manages the settlement of funds or other types of assets associated with one or more transactions handled by financial management system 102.

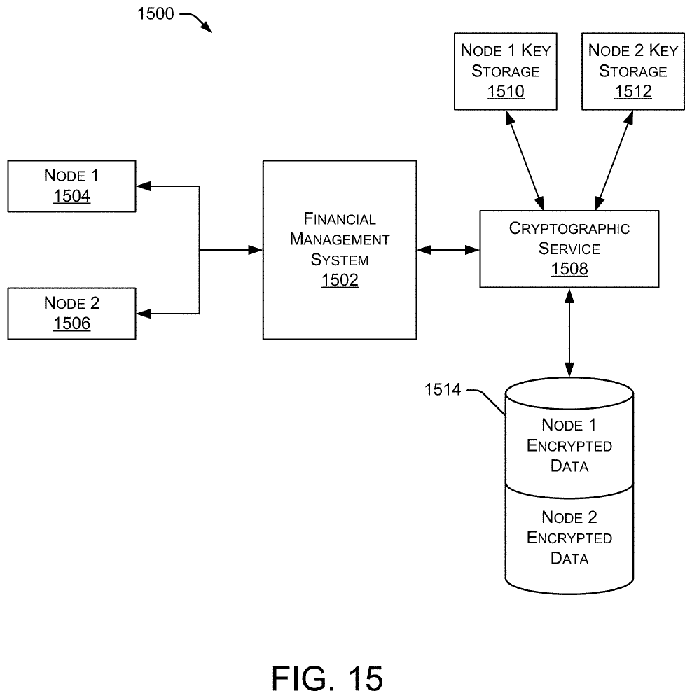

Financial management system 102 also includes a ledger manager 212 that manages a ledger (e.g., ledger 118 in FIG. 1) as discussed herein. A FedWire, NSS (National Settlement Service), ACH (Automated Clearing House), Interchange module 214 provides a service used to interact with standard protocols like FedWire and ACH for the settlement of funds. A blockchain module 216 provides interoperability with blockchains for settlement of assets on a blockchain. A database ledger and replication module 218 provides a service that exposes constructs of a ledger to the financial management system. Database ledger and replication module 218 provides functionality to store immutable transaction states with the ability to audit them. The transaction data can also be replicated to authorized nodes for which they are either a principal or an observer. Although particular components are shown in FIG. 2, alternate embodiments of financial management system 102 may contain additional components not shown in FIG. 2, or may not contain some components shown in FIG. 2. Although not illustrated in FIG. 2, financial management system 102 may contain one or more processors, one or more memory devices, and other components such as those discussed herein with respect to FIG. 15.

In the example of FIG. 2, various modules, components, and systems are shown as being part of financial management system 102. For example, financial management system 102 may be implemented, at least in part, as a cloud-based system. In other examples, financial management system 102 is implemented, at least on part, in one or more data centers. In some embodiments, some of these modules, components, and systems may be stored in (and/or executed by) multiple different systems. For example, certain modules, components, and systems may be stored in (and/or executed by) one or more financial institutions.

As mentioned above, system/platform integrity is important to the secure operation of financial management system 102. This integrity is maintained by ensuring that all actions are initiated by authorized users or systems. Additionally, once an action is initiated and the associated data is created, an audit trail of any changes made and other information related to the action is recorded for future reference.

In particular embodiments, financial management system 102 includes (or interacts with) a roles database and an authentication layer. The roles database stores various roles of the type discussed herein.

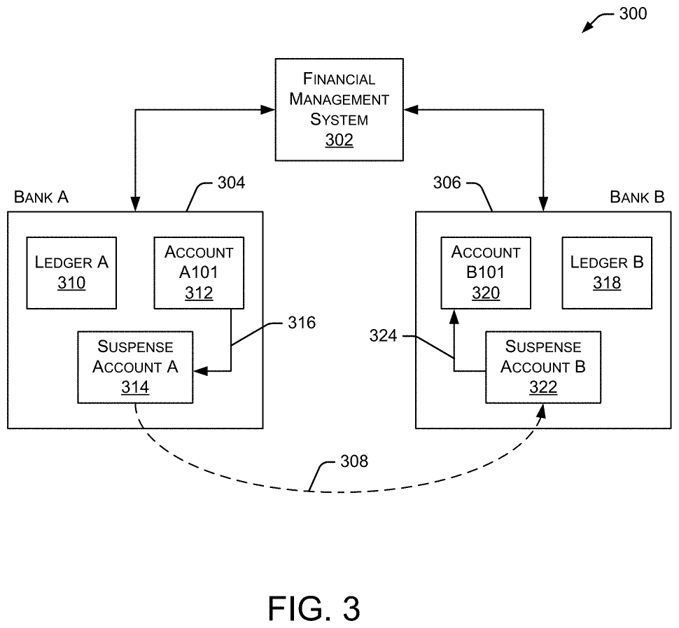

FIG. 3 illustrates an embodiment 300 of an example asset transfer between two financial institutions. In the example of FIG. 3, financial management system 302 is in communication with a first bank 304 and a second bank 306. In this example, funds are being transferred from an account at bank 304 to an account at bank 306, as indicated by broken line 308. Bank 304 maintains a ledger 310 that identifies all transactions and data associated with transactions that involve bank 304. Similarly, bank 306 maintains a ledger 318 that identifies all transactions and data associated with transactions that involve bank 306. In some embodiments, ledgers 310 and 318 (or the data associated with ledgers 310 and 318) reside in financial management system 302 as a shared, permissioned ledger, such as ledger 118 discussed above with respect to FIG. 1.

In the example of FIG. 3, funds are being transferred out of an account 312 at bank 304. To facilitate the transfer of funds out of account 312, the funds being transferred are moved 316 from account 312 to a first suspense account 314 at bank 304. Each suspense account discussed herein is a “For Benefit Of” (FBO) account and is operated by the financial management system for the members of the network (i.e., all parties and principals). The financial management system may facilitate the transfer of assets into and out of the suspense accounts. However, the financial management system does not take ownership of the assets in the suspense accounts. The credits and debits associated with each suspense account are issued by the financial management system and the ledger (e.g., ledger 118 in FIG. 1) is used to track ownership of the funds in the suspense accounts. Each suspense account has associated governance rules that define how the suspense account operates. At bank 306, the transferred funds are received by a second suspense account 322. The funds are moved 324 from second suspense account 322 to an account 320 at bank 306. In some embodiments, a suspense account may be referred to as a settlement account.

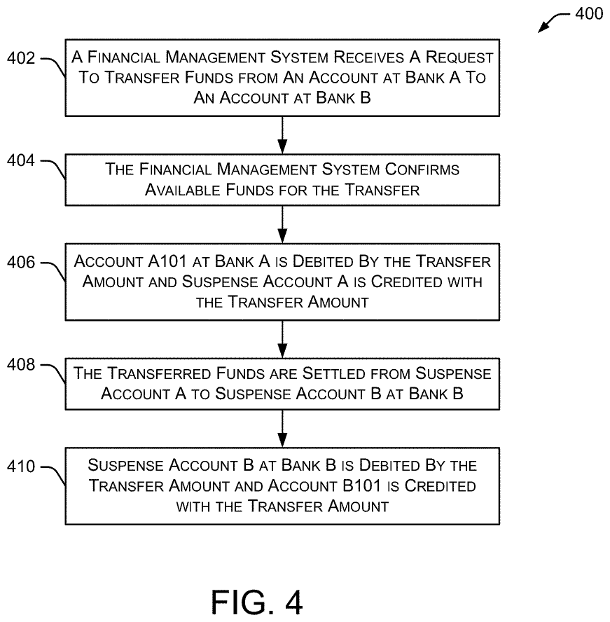

As discussed herein, financial management system 302 facilitates the transfer of funds between bank 304 and 306. Additional details regarding the manner in which the funds are transferred are provided below with respect to FIG. 4. Although only one account and one suspense account are shown for each bank in FIG. 3, particular embodiments of bank 304 and 306 may contain any number of accounts and suspense accounts. Additionally, bank 304 and 306 may contain any number of ledgers and other systems. In some embodiments, each suspense account 314, 322 is established as part of the financial institution “onboarding” process with the financial management system. For example, the financial management system administrators may work with financial institutions to establish suspense accounts that can interact with the financial management system as described herein.

In some embodiments, one or more components discussed herein are contained in a traditional infrastructure of a bank or other financial institution. For example, an HSM (Hardware Security Module) in a bank may execute software or contain hardware components that interact with a financial management system to facilitate the various methods and systems discussed herein. In some embodiments, the HSM provides security signatures and other authentication mechanisms to authenticate participants of a transaction.

FIG. 4 illustrates an embodiment of a method 400 for transferring assets (e.g., funds) between two financial institutions. Initially, a financial management system receives 402 a request to transfer funds from an account at Bank A to an account at Bank B. The request may be received by Bank A, Bank B, or another financial institution, system, device, and the like. Using the example of FIG. 3, financial management system 302 receives a request to transfer funds from account 312 at bank 304 to account 320 at bank 306.

Method 400 continues as the financial management system confirms 404 available funds for the transfer. For example, financial management system 302 in FIG. 3 may confirm that account 312 at bank 304 contains sufficient funds to satisfy the amount of funds defined in the received transfer request. In some embodiments, if available funds are confirmed at 404, the financial management system creates suspense account A at Bank A and creates suspense account B at Bank B. In particular implementations, suspense account A and suspense account B are temporary suspense accounts created for a particular transfer of funds. In other implementations, suspense account A and suspense account B are temporary suspense accounts but are used for a period of time (or for a number of transactions) to support transfers between bank A and bank B.

If available funds are confirmed at 404, then account A101 at Bank A is debited 406 by the transfer amount and suspense account A (at Bank A) is credited with the transfer amount. Using the example of FIG. 3, financial management system 302 debits the transfer amount from account 312 and credits that transfer amount to suspense account 314. In some embodiments, ownership of the transferred assets changes as soon as the transfer amount is credited to suspense account 314.

The transferred funds are then settled 408 from suspense account A (at Bank A) to suspense account B (at Bank B). For example, financial management system 302 in FIG. 3 may settle funds from suspense account 314 in bank 304 to suspense account 322 in bank 306. The settlement of funds between two suspense accounts is determined by the counterparty rules set up between the two financial institutions involved in the transfer of funds. For example, a counterparty may choose to settle at the top of the hour or at a certain threshold to manage risk exposure. The settlement process may be determined by the asset type, the financial institution pair, and/or the type of transaction. In some embodiments, transactions can be configured to settle in gross or net. For gross transaction settlement of a PVP workflow, the settlement occurs instantaneously over existing protocols supported by financial institutions, such as FedWire, NSS, and the like. Netted transactions may also settle over existing protocols based on counterparty and netting rules. In some embodiments, the funds are settled after each funds transfer. In other embodiments, the funds are settled periodically, such as once an hour or once a day. Thus, rather than settling the two suspense accounts after each funds transfer between two financial institutions, the suspense accounts are settled after multiple transfers that occur over a period of time. Alternatively, some embodiments settle the two suspense accounts when the amount due to one financial institution exceeds a threshold value.

Method 400 continues as suspense account B (at Bank B) is debited 410 by the transfer amount and account B101 at Bank B is credited with the transfer amount. For example, financial management system 302 in FIG. 3 may debit suspense account 322 and credit account 320. After finishing step 410, the funds transfer from account 312 at bank 304 to account 320 at bank 306 is complete.

In some embodiments, the financial management system facilitates (or initiates) the debit, credit, and settlement activities (as discussed with respect to FIG. 4) by sending appropriate instructions to Bank A and/or Bank B. The appropriate bank then performs the instructions to implement at least a portion of method 400. The example of method 400 can be performed with any type of asset. In some embodiments, the asset transfer is a transfer of funds using one or more traditional currencies, such as U.S. Dollars (USD) or Great British Pounds (GBP).

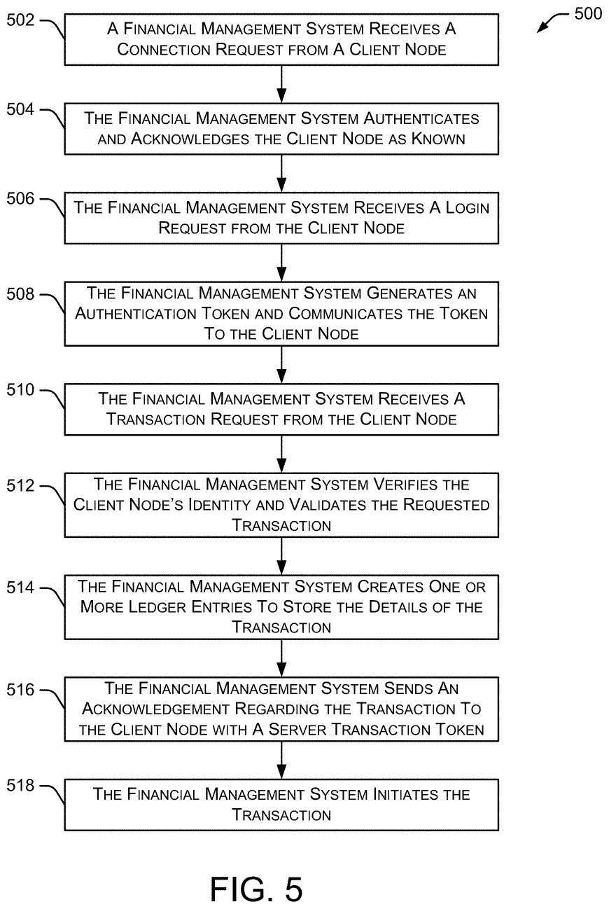

FIG. 5 illustrates an embodiment of a method 500 for authenticating a client and validating a transaction. Initially, a financial management system receives 502 a connection request from a client node, such as a financial institution, an authorized system, an authorized user device, or other client types mentioned herein. The financial management system authenticates 504 and, if authenticated, acknowledges the client node as known. Method 500 continues as the financial management system receives 506 a login request from the client node. In response to the login request, the financial management system generates 508 an authentication token and communicates the authentication token to the client node. In some embodiments, the authentication token is used to determine the identity of the user for future requests, such as fund transfer requests. The identity is then further checked for permissions to the various services or actions.

The financial management system further receives 510 a transaction request from the client node, such as a request to transfer assets between two financial institutions or other entities. In response to the received transaction request, the financial management system verifies 512 the client node's identity and validates the requested transaction. In some embodiments, the client node's identity is validated based on an authentication token, and then permissions are checked to determine if the user has permissions to perform a particular action or transaction. Transfers of assets also involve validating approval of an account by multiple roles to avoid compromising the network. If the client node's identity and requested transaction are verified, the financial management system creates 514 one or more ledger entries to store the details of the transaction. The ledger entries may be stored in a ledger such as ledger 118 discussed herein. The financial management system then sends 516 an acknowledgement regarding the transaction to the client node with a server transaction token. In some embodiments, the server transaction token is used at a future time by the client when conducting audits. Finally, the financial management system initiates 518 the transaction using, for example, the systems and methods discussed herein.

In some embodiments, various constructs are used to ensure data integrity. For example, cryptographic safeguards allow a transaction to span 1-n principals. The financial management system ensures that no other users (other than the principals who are parties to the transaction) can view data in transit. Additionally, no other user should have visibility into the data as it traverses the various channels. In some embodiments, there is a confirmation that a transaction was received completely and correctly. The financial management system also handles failure scenarios, such as loss of connectivity in the middle of the transaction. Any data transmitted to a system or device should be explicitly authorized such that each entry (e.g., ledger entry) can only be seen and read by the principals who were a party to the transaction. Additionally, principals can give permission to regulators and other individuals to view the data selectively.

Cryptographic safeguards are used to detect data tampering in the financial management system and any other systems or devices. Data written to the ledger and any replicated data may be protected by:
Stapling all the events associated with a single transaction.
Providing logical connections of each commit to those that came before it are made.
The logical connections are also immutable but principals can send messages for relinking. In this case, the current and all preceding links are maintained. For example, trade amendments are quite common. A trade amendment needs to be connected to the original trade. For forensic analysis, a bank may wish to identify all trades by a particular trader. Query characteristics will be graphs, time series, and RDBMS (Relational Database Management System).

In some embodiments, the financial management system monitors for data tampering. If the data store (central data store or replicated data store) is compromised in any way and the data is altered, the financial management system should be able to detect exactly what changed. Specifically, the financial management system should guarantee all participants on the network that their data has not been compromised or changed. Information associated with changes are made available via events such that the events can be sent to principals via messaging or available to view on, for example, a user interface. Regarding data forensics, the financial management system is able to determine that the previous value of an attribute was X, it is now Y and it was changed at time T, by a person A. If a system is hacked or compromised, there may be any number of changes to attribute X and all of those changes are captured by the financial management system, which makes the tampering evident.

In particular embodiments, the financial management system leverages the best security practices for SaaS (Software as a Service) platforms to provide cryptographic safeguards for ensuring integrity of the data. For ensuring data integrity, the handshake between the client and an API server (discussed with respect to FIG. 6) establish a mechanism which allows both the client and the server to verify the authenticity of transactions independently. Additionally, the handshake provides a mechanism for both the client and the server to agree on a state of the ledger. If a disagreement occurs, the ledger can be queried to determine the source of the conflict.

FIG. 6 is a block diagram illustrating an embodiment 600 of a financial management system 602 interacting with an API server 608 and an audit server 610. Financial management system 602 also interacts with a data store 604 and a ledger 606. In some embodiments, data store 604 and ledger 606 are similar to data store 116 and ledger 118 discussed herein with respect to FIG. 1. In particular implementations, API server 608 exposes functionality of financial management system 602, such as APIs that provide reports of transactions and APIs that allow for administration of nodes and counterparties. Audit server 610 periodically polls the ledger to check for data tampering of ledger entries. This check of the ledger is based on, for example, cryptographic hashes and are used to monitor data tampering as described herein.

In some embodiments, all interactions with financial management system 602 or the API server are secured with TLS. API server 608 and audit server 610 may communicate with financial management system 602 using any type of data communication link or data communication network, such as a local area network or the Internet. Although API server 608 and audit server 610 are shown in FIG. 6 as separate components, in some embodiments, API server 608 and/or audit server 610 may be incorporated into financial management system 602. In particular implementations, a single server may perform the functions of API server 608 and audit server 610.

In some embodiments, at startup, a client sends a few checksums it has sent and transaction IDs to API server 608, which can verify the checksums and transaction IDs, and take additional traffic from the client upon verification. In the case of a new client, mutually agreed upon seed data is used at startup. A client request may be accompanied by a client signature and, in some cases, a previous signature sent by the server. The server verifies the client request and the previous server signature to acknowledge the client request. The client persists the last server signature and a random set of server hashes for auditing. Both client and server signatures are saved with requests to help quickly audit correctness of the financial management system ledger. The block size of transactions contained in the request may be determined by the client. A client SDK (Software Development Kit) assists with the client server handshake and embedding on server side signatures. The SDK also persists a configurable amount of server signatures to help with restart and for random audits. Clients can also set appropriate block size for requests depending on their transaction rates. The embedding of previous server signatures in the current client block provides a way to chain requests and provide an easy mechanism to detect tampering. In addition to a client-side signature, the requests are encrypted using standard public key cryptography to provide additional defense against client impersonation. API server 608 logs all encrypted requests from the client. The encrypted requests are used, for example, during data forensics to resolve any disputes.

In particular implementations, a client may communicate a combination of a previous checksum, a current transaction, and a hash of the current transaction to the financial management system. Upon receipt of the information, the financial management system checks the previous checksum and computes a new checksum, and stores the client hash, the current transaction, and the current checksum in a storage device, such as data store 604. The checksum history and hash (discussed herein) protect the integrity of the data. Any modification to an existing row in the ledger cannot be made easily because it would be detected by mismatched checksums in the historical data, thereby making it difficult to alter the data.

The integrity of financial management system 602 is ensured by having server audits at regular intervals. Since financial management system 602 uses chained signatures per client at the financial management system, it ensures that an administrator of financial management system 602 cannot delete or update any entries without making the ledger tamper evident. In some embodiments, the auditing is done at two levels: a minimal level which the SDK enforces using a randomly selected set of server signatures to perform an audit check; and a more thorough audit check run at less frequent intervals to ensure that the data is correct.

In some implementations, financial management system 602 allows for the selective replication of data. This approach allows principals or banks to only hold data for transactions they were a party to, while avoiding storage of other data related to transactions in which they were not involved. Additionally, financial management system 602 does not require clients to maintain a copy of the data associated with their transactions. Clients can request the data to be replicated to them at any time. Clients can verify the authenticity of the data by using the replicated data and comparing the signature the client sent to the financial management system with the request.

In some embodiments, a notarial system is used to maintain auditability and forensics for the core systems. Rather than relying on a single notary hosted by the financial management system, particular embodiments allow the notarial system to be installed and executed on any system that interacts with the financial management system (e.g., financial institutions or clients that facilitate transactions initiated by the financial management system).

The systems and methods discussed herein support different asset classes. Each asset class may have a supporting set of metadata characteristics that are distinct. Additionally, the requests and data may be communicated through multiple “hops” between the originating system and the financial management system. During these hops, data may be augmented (e.g., adding trade positions, account details, and the like) or changed.

In certain types of transactions, such as cash transactions, the financial management system streamlines the workflow by supporting rich metadata accompanying each cash transfer. This rich metadata helps banks tie back cash movements to trades, accounts, and clients.

As discussed herein, the described systems and methods facilitate the movement of assets between principals (also referred to as “participants”). The participants are typically large financial institutions in capital markets that trade multiple financial products. Trades in capital markets can be complex and involve large asset movements (also referred to as “settlements”). The systems and methods described herein can integrate to financial institutions and central settlement authorities such as the US Federal Reserve or DTCC (Depository Trust & Clearing Corporation) to facilitate the final settlement of assets. The described systems and methods also have the ability to execute workflows such as DVP, threshold based settlement, or time-based settlement between participants. Using the workflows, transactions are settled in gross or net amounts.

The systems and methods described herein include a platform and workflow to support and enable 3rd party guarantors the ability to view payment activity between participants in real time (or substantially real time), and step in to make payments on behalf of participants when necessary.

As mentioned above, the systems and methods discussed herein may perform various operations and procedures related to trade finance between two or more entities, individuals, or parties. For example, the trade finance operations and procedures may be associated with a transaction between a seller and a buyer of goods or services, a transaction between an exporter and an importer, and the like.

In many situations, business runs on finding the information relevant to their goals (Insights) and being able to take Action on those insights. Insights and Actions should go hand-in-hand. However, many prevailing processes and tools address each aspect of a problem in silos. This causes users to first get insights in one tool, and then take action in a separate tool using different processes and data (and going back-and-forth multiple times). This causes inefficiencies in taking action (e.g., wrong action, delay in taking action, incomplete action, mistakes in action, learning curve in taking action, and the like). This eventually impacts the business outcomes. The systems and methods described herein allow users to combine finding relevant insights with relevant action at one place. Users can find the information easily and be able to take specific (sometimes predefined) action. The described systems and methods build the action instructions automatically based on the insights being sought. This will eliminate (or reduce) delay and mistakes in taking action and reduce the learning curve.

In some embodiments, the described systems and methods achieve this by having a data pipeline that is business context aware, having setup self-learning tools that continue to enrich meta-data (e.g., data-dictionary, mapping and synonyms) as well as types of insights users are looking for, and pre-build workflows that allow native support for actions to be taken based on the insights derived. For example, a data pipeline may include data associated with asset positions at various accounts, asset classes, asset types, settlement instructions, products being traded, margin calls, trade positions and client vs. house data. Work flows may include, for example, data associated with a pledge, recall, substitution, margin call notification, and excess collateral notification. One or more pre-built models may include data associated with, for example, COD, margin calls, margin call history, and excess/deficit history. In particular implementations, the insights are generated using packaged queries, statistical anomalies, and/or learned queries. The packaged queries are designed based on business needs of end users. The described systems and methods can learn and track key business metrics. Any deviations from those metrics (e.g., statistical anomalies) are flagged as areas to investigate and potentially generate insight for the user. The described systems and methods will continuously learn the type and consequence of queries run by end users across the enterprise. Based on this learning, the systems and methods may run one or more of these sequences of queries automatically and provide key insights proactively.

Example treasury metrics include:

1. Global long box—Current balances and position breakdown by following venue/account (and further breakdown by asset class, asset type, etc.) and asset classes (e.g., given an asset class, the venues they are in).

2. Liquidity ladders—Asset outflow vs. asset inflow reports aggregated over past N days. Ability to breakdown by asset class and asset type.

3. Liquidity Management—Cash demands: predictive analytics based on cutoff times for forward legs of cash outflows and cash inflows (e.g., from clients).

Example risk/audit metrics include:

1. Settlements (e.g., end-to-end including SWIFT).
For actions that exceed a certain value (e.g., greater than 500 M at CME for past 10 days).
For a specific action (e.g., pledge for client-A's ISIN).
All pledges/recalls by asset class for past N days (e.g., all cash pledgers for past 5 days).

2. Audits—Complete state diagram including approvals for a particular action (not just settlements).

Based on the insights, the described systems and methods generate one or more recommendations, such as “You have excess collateral at CME. Would you like to reduce excess collateral at the CME?” If the user wants to take action based on the recommendation, the following sequence may occur:

1. Pre-action: The systems and methods automatically pull relevant parameters from the previously presented insights and/or recommendations. The user is presented with options to adjust context relevant parameters (e.g., Exchange: CME, Excess to reduce: $2 M, Optimize: Yes, etc.)

2. Actions: This will trigger one or more workflows based on the parameters from the pre-action. An example can be to “Optimize” asset excess when making a decision to “recall”.

3. Post-action: The systems and methods will present the user with a relevant reference and/or status coming out of (e.g., resulting from) the action.

An example process is shown below:

1. Search: Type in and/or Autofill (contextual)

2. Data Presentation: Dynamic, recommended graph

3. Insight:
a. Learned Behavior
b. Packaged Queries
c. Anomalies (statistical)

4. Recommendation

5. Actions
a. Optimizer
b. Way to adjust
c. Execute

The systems and methods described herein represent example embodiments that provide (and/or implement) a data platform capable of helping users find relevant insights as well as relevant actions associated with the insights.

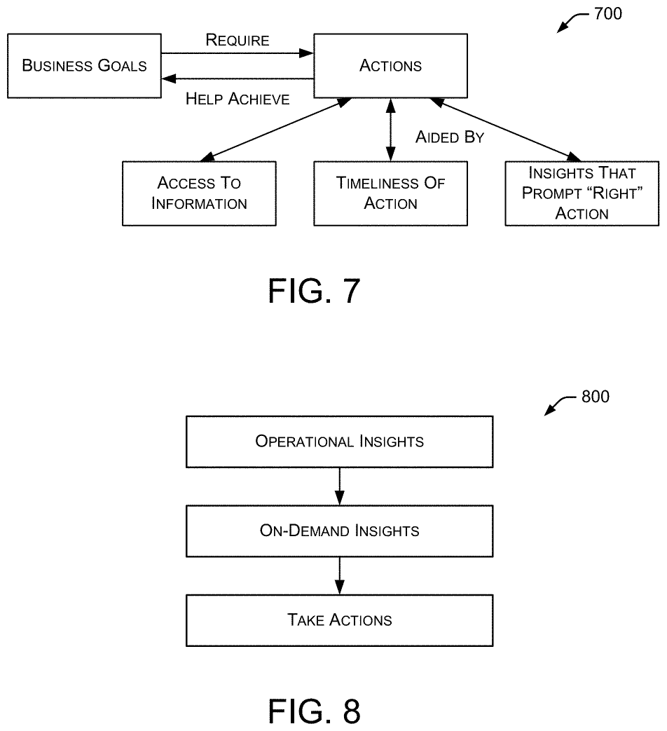

FIG. 7 illustrates an embodiment of a process 700 for achieving goals by making decisions and taking actions. The goals may be any type of goal set by an individual or entity, such as financial goals, transactional goals, company goals, department goals, and the like. In some embodiments, one or more goals may be associated with a financial transaction (or financial transaction data) of the type discussed herein.

Achieving a goal may require multiple people or teams to take various actions, such as decision-making actions or operational actions. In many situations, access to information and data, as well as analysis and processing of the information and data, is important in making good decisions. In particular, insightful information can be powerful in making decisions and taking appropriate actions. Additionally the timeliness (e.g., speed) of information and insights may help in taking actions sooner, thereby increasing the likelihood of meeting different types of goals. In some situations, tying an insight to an action can improve achievement of one or more goals.

As shown in FIG. 7, business goals often require one or more actions to help achieve the desired goals. As discussed in greater detail herein, these actions may be aided by various types of data analysis, access to information/data, the timeliness of the action, and insights that prompt or suggest a “correct” action.

FIG. 8 illustrates an embodiment of a process 800 that uses both operational insights and on-demand insights to identify one or more actions. In some embodiments, the process 800 works with a data platform that ties both operational insights and on-demand insights to actions. The actions can be taken by users or can be automated based on rules or models developed as part of the platform.

As shown in FIG. 8, the process 800 generates operational insights as well as on-demand insights to suggest particular actions to achieve, for example, one or more goals. In some embodiments, operational insights include, for example, trends and anomalies tracked on an hourly, daily, or weekly basis. Additionally, on-demand insights include, for example, more interactive and user-driven analysis.

In some embodiments, the systems and methods described herein use three components: a data layer, workflows, and pre-built domain-specific models. As discussed herein, these three components enable users to achieve business goals by taking action. Example business goals and actions may be associated with topics such as capital efficiency, operational efficiency, and lower risk. For example, capital efficiency goals may be related to reducing pre funding and maximizing ROR (Return On Revenue). Additionally, operational efficiency goals may be related to the cost of settlements (e.g., overdrafts and message costs) and reducing people's times (e.g., mistakes that they make and corrections). Lower risk goals may be related to the time to settle transactions (e.g., settlement risks) and settlement costs to cut off.

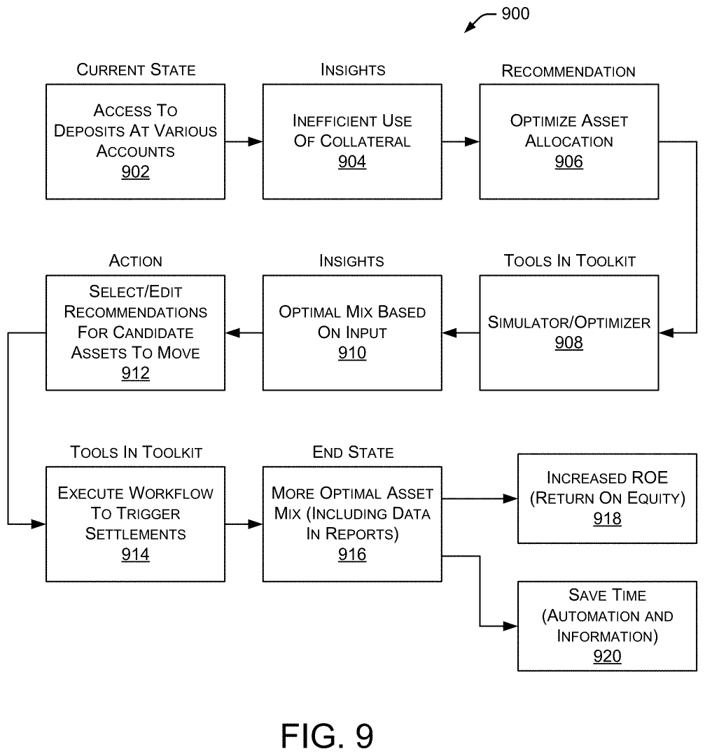

FIG. 9 illustrates an embodiment of a process 900 for achieving goals or other tasks based on various decisions, actions, analysis, and the like. In the example of FIG. 9, the desired goal is to increase the company's ROE (Return On Equity). Process 900 begins at a current state 902 with obtaining access to assets on deposit at various accounts. Insights 904 are gained regarding inefficient use of capital (e.g., based on current asset and deposit information) and a recommendation 906 is generated to optimize asset allocation. One or more tools 908 may be associated with recommendation 906, such as a simulator/optimizer tool to help optimize allocation of assets. Insights 910 are obtained regarding an optimal mix of assets based on various input (e.g., the asset optimization recommendation and results from the simulator/optimizer tool). A user may then take action 912 by selecting or editing recommendations for candidate asset moves. One or more tools 914 in a toolkit may execute a workflow to trigger settlements associated with one or more asset moves. Finally, an end state 916 is reached where there is a more optimal asset mix and reports to show the changes and the new allocation of assets. The result of end state 916 is increased ROE 918 and time saved 920 in achieving the goal via the automation steps, insights, and other information.

The systems and methods described herein provide actionable information and assistance by allowing users to receive the insights and turn the insights into an action that can help to achieve the goal(s). Additionally, the systems and methods don't just present data, the systems and methods understand the data and learn about the context of the data and the follow-up actions that have been seen in previous situations (e.g., when processing previous goals). Thus, the systems and methods can generate insightful recommendations based on detected patterns, anomalies, and the like. Further, the systems and methods allow a user to submit queries via a contextual search. The context is built on purpose based on the financial domain models, such as for collateral or foreign exchange.

The systems and methods described herein may define a data platform and/or a data structure to implement the features and operations discussed herein. In some embodiments, the systems and methods described herein define some high-level basic concepts and associated configuration metadata that define the overall common view for all applications. These can be divided into financial domain constructs (e.g., nodes, accounts, assets, contracts, and the like) and application-level constructs (e.g., users, roles, and the like).

At a lower level the systems and methods define abstract constructs for building application features, notably a Data Pipeline Layer to define, ingest, store, and query data in an abstract way; and a Workflow subsystem to define and execute computational/procedural/transactional operations. Both of these are based on pre-built sub-domain specific models to enable insights and definitions of rules to take manual or automated actions.

In some embodiments, various rules and models are created specific to a domain initially. For example, collateral will have a model that will be different from an FX model. The described systems and methods create the rules and models by incorporating business domain knowledge with the historical data. The initial models may be further customized and tuned for customer specific needs and/or data availability.

Data Layer

The data layer acts as a data store abstraction for data needing to be held in a system (e.g., the systems and methods described herein). The data layer includes an abstract Schema mechanism for describing the data needing to be stored. This is distinct from any specific underlying database schemas. Having described a subschema for a data component, it can be used to populate and query the data described. The storage of the data is managed by the data layer: data may be stored in relational tables or in NoSQL storage as needed. In some embodiments, the data layer supports or completely automates creation of indexes, aggregates, and the like. In some implementations, the data layer is fundamentally a relational model and the implementation underneath is primarily SQL-based. But, some components outside the data layer may not generally access that directly.

There are several reasons for an abstracted data layer. First, for extensibility, it may be advantageous to not have application-specific database schemas and queries defined in source code, as this requires new code to be written, tested, released, and managed to add new data. The data layer allows changes or additions to data store objects in metadata/configuration instead. Second, by consolidating database logic into the common platform, the systems and methods can share and leverage capabilities across application modules. Third, by defining the data layer as metadata-driven, the systems and methods can support ad-hoc, including interactive, querying (independent of the underlying database implementation, but with awareness of the capabilities of the described systems and methods). This allows capabilities like an insight tool to be added easily across multiple products.

For example, many Web Applications are built using an Object-Relational Mapping (ORM) model in which application-specific Java classes correspond one-to-one to rows in application-specific RDBMS tables. If the table contains a “name” column, the corresponding Java class has a “name” member. Via the ORM library, the relationship is maintained and updating the value in one place is reflected in the other. Similarly, queries can in many cases be done by simply naming a method as, for example, findByValueDateAndMatchedTradeId (the framework automatically converts this into a SQL query based on parsing the function name). This is convenient for quickly producing single-purpose applications, but does require changes to the code to make data changes like adding a new column and vice versa. In some embodiments, a more metadata-driven approach is used, which bases all queries (including DML) on either external configuration or on data introspection, rather than hard-coding.

Schema

In some embodiments, the described systems and methods include a schema that defines the overall content of the data layer in any given instance. The schema's definition is stored in, for example, the primary metadata. The schema is divided into a number of grouping objects, similar to table definitions in SQL, which may be referred to as collections. In some embodiments, a collection contains a number of fields each having a name, data type, and properties (as in a SQL table), but has additional properties supporting the systems and methods described herein. The representation of the schema can be navigated/queried/modified by APIs. In some embodiments, the data layer will instantiate and maintain the schema in the underlying data store. Generally, each collection will map to a table. In particular implementations, some extensibility features may leverage introspection via database-level metadata.

In some embodiments, the schema definition language may be capable of describing any data that the systems and methods will be manipulating at an abstract level, from storage definition to reporting, analytics querying to ingestion, and stream processing.

Storage

In the underlying database(s), the data layer will manage tables corresponding to the schema collections. In some situations, additional tables will be constructed as necessary to implement certain optimizations (e.g., aggregate tables). Indexes will be managed based on schema notations and query patterns. Not all data will necessarily be stored in the same underlying database. Data for analytical querying may be stored in a data warehouse context such as Hive and still under the umbrella of the described schema.

Querying

In some embodiments, querying is specified relative to the schema discussed herein. One effective approach would be to expose a SQL-based query language (e.g., possibly a superset but in any event a supporting basic standard SQL syntax) because a) developers (including consultants) will be familiar with that, and b) automated tools and libraries can work with it.

In some embodiments, a special case of querying is evaluating simpler expressions such as “3*(v1+v2)”, which occurs in many places (including in workflows). Such expressions are a subset of basic SQL (e.g., “select 3*(v1+v2)”) and can be used in many contexts using the same data layer expression subsystem. For simple expressions without FROM the context/symbol-table (e.g., where to get the values of v1 and v2), can be provided externally. In some implementations, this level of expression interpretation can substantially support a REPL (Read, Evaluate, Print, Loop) implementation.

Ingestion Support

The ingestion of data is an ETL (Extract, Transform, Load) problem where the source data must be described and extracted from various sources, then transformed to the intended schema-defined format, and loaded into the actual datastore. Data may come via file transfer, record streams, database connections, HTML or other protocol scraping, and the like. The data format may be text defined by CSV, XML, JSON, fixed-fields, regex-parsable, etc. The data format may also be structured (as via DB connectivity).

The described systems and methods will support underlying implementations of multiple ingestion sources. Each will be metadata driven so that the source/connectivity and expected record/columns are defined (according to the particular data format) and corresponding records can be fetched and injected into the target data store.

In some embodiments, the configuration of an ingestion source can be decomposed into several aspects:

1. The connectivity (e.g., the way data comes into the system). Connectors include queues (RabbitMQ, ActiveMQ, Kinesis, etc.), SFTP file transfer, HTTP transfer, databases (JDBC, MongoDB, etc.), and the like. Each of these will have basic configuration requirements such as URL, credentials, queue name, HTTP parameters, DB schema, and DB query. Given the correct configuration, the connector will produce raw data according to a common model (e.g., as a sequence or stream of strings). The raw form of the data will a) be stored in a Data Lake (e.g., S3) for auditing and advanced analytics; and b) fed into the parser/mapper stage in (3) below for further processing.

2. A schedule for accessing the data. For data being pushed to the systems and methods on a stream, this might be “as available”. For polling, this would indicate when to a) check for inbound data, such as checking a SFTP directory, or b) initiate a check for new data, such as by making an HTTP request.

3. A specification of how to normalize the raw data into one or more schema-aware record streams. In some embodiments, this is in two parts: parsing and mapping.

a. Parsing converts the raw data into a sequence of fields. For CSV, character-position-based extraction, and content-based (regex) extraction, the configuration has the specific parameters (e.g., regular expressions, positions, and the like). For predefined formats such as XML and JSON, or in the case of JDBC and other database APIs, the parsing is implicit.

b. Mapping provides interpretation for fields, to relate them to schema-defined metadata (e.g., name and type for fields) and to specify conversions such as date formats. Mapping can also include “select”-like operations to limit the fields included in the result, renaming or computing fields, or filtering.

The result of the ingestion process is to generate one or more streams of records associated with the schema metadata. These can then be directed into storage, also schema-defined. In some embodiments, a mechanism for expressing the entire ETL process would be to use something like an INSERT INTO<schema table name>SELECT<mapping>FROM<ingestion source> . . . query.

Workflows

The workflow subsystem manages the definition and execution of workflow programs. A workflow definition describes a workflow program similarly to the way programming language source files describe executable programs. A workflow definition describes a set of formal parameters and a sequence of control statements (conditionals, forks, etc.) and action invocations, structured into sequences of transactions. A workflow service/engine can execute a workflow definition, (e.g., supply a set of actual parameters and process the statements in order, evaluating conditionals to control the sequence of operations, and applying action invocations). In some embodiments, the set of actions available is hard-coded (e.g., SEND_MT900, RECEIVE_MT900, etc.) and may also be extensible.

In some embodiments, parts of workflow execution can be viewed as similar to the evaluation of simple expressions discussed with respect to data layer and querying. The actual parameters become the symbol table for expression evaluation. In some embodiments, the workflow is macro/text-substitution oriented (“${symbol}”). In other embodiments, a common expression subsystem may allow for more consistent usage.

Domain Specific Models

Domain specific models provide information for the individual applications as well as the data platform in general. In some embodiments, the basic objects are predefined (e.g., nodes, contracts, etc.), but are extensible in the sense that new kinds of trades, for example, can be supported.

An example model includes:

Nodes
Accounts
   Assets

Contracts
Trades

Users

Roles

In some embodiments, the objects have events associated with them which could be the result of workflows or actions initiated by the user or the system. Events are related to (e.g., include a reference to) objects and are the mechanism for triggering workflows. Events and their lineage are maintained in the platform to reach object state transitions

Actions

Actions result in events on the objects defined in the domain specific model. For example, actions can be initiated by the following:

Manually by a user

Triggered by a workflow

Auto triggered based on some criteria (e.g., a rule)

In some embodiments, a rule is a code snippet expressed based on a data platform that returns a Boolean (TRUE|FALSE) response. A rule may have a name just like a function has a name. In some implementations, a rule is a function that has a Boolean return value. For example, a rule can have the following primitives:

Any expression as stated above

If (Boolean expression) else

Return TRUE|FALSE

A rule can be in a state of {active, inactive, test}. In some embodiments, only active rules can be run in production and only active and test can be run in development and staging. This approach helps manage the rulesets better and prevent accidental deletion of a critical rule that may have other regressions.

In some embodiments, a rule has a version number. This may be an auto-increment number (Never Overwrite/Update a rule). New rules should be created with a version number. In some embodiments, an instance of a rule can only be explicitly deleted in which case the lineage will be lost. By comparing the version number of the rule, the systems and methods will be able to see the lineage of the rule.

In some situations, a rule can reference another rule. All references for active, inactive and test rules should be maintained. In some embodiments, an active rule can only be referenced by other active, inactive or test rules. An inactive rule can only be referenced by other inactive or test rules. And a test rule can only be referenced by other test rules.

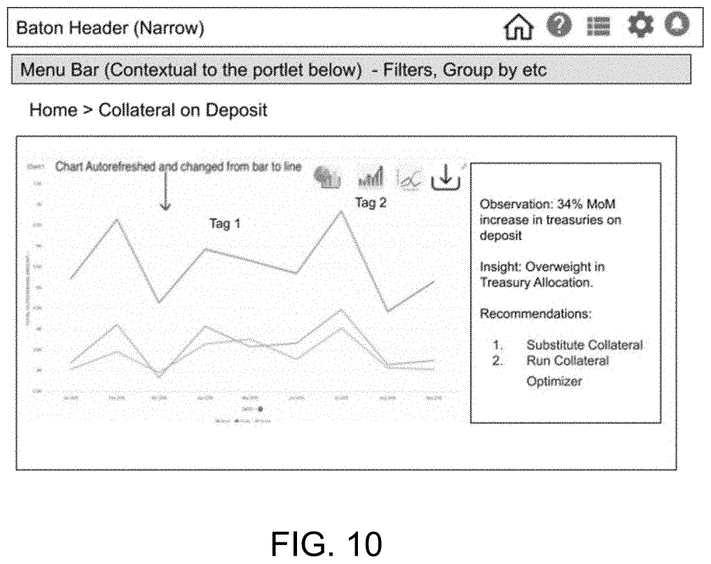

FIG. 10 illustrates an example implementation of identifying specific data and other information. The example of FIG. 10 includes standard/operational insight along with proposed actions a user can take, such as substituting collateral because something cheaper is available as an insight from the graph shown in the figure.

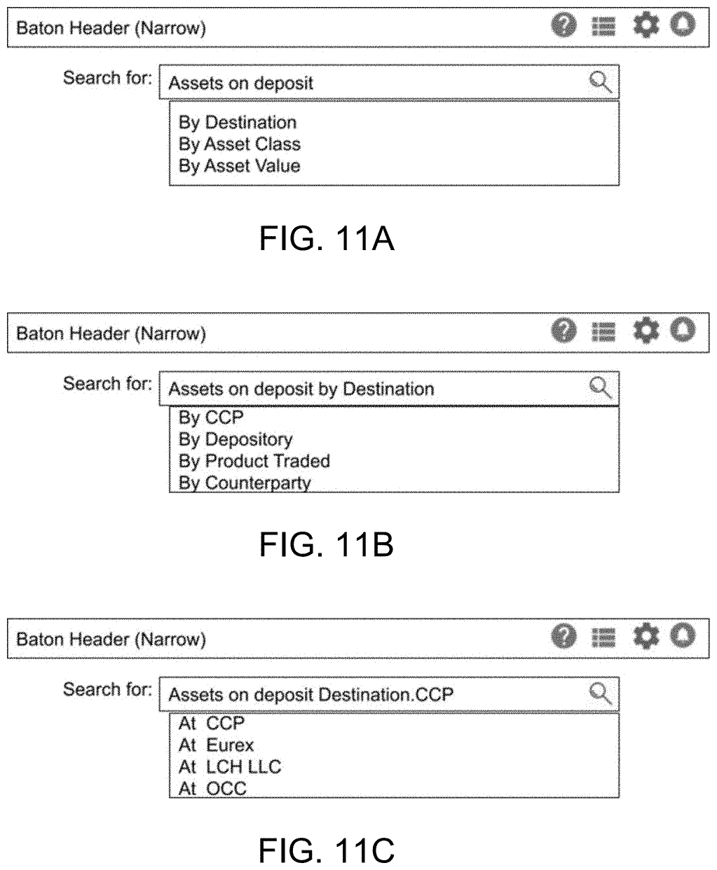

FIGS. 11A-11C illustrate an example process of identifying specific data and other information. For example, FIGS. 11A-11C illustrate various filters a user may apply to analyze the data. In some embodiments, these are dynamic filters (instead of standard filters) that adjust based on user selections and previous inputs.

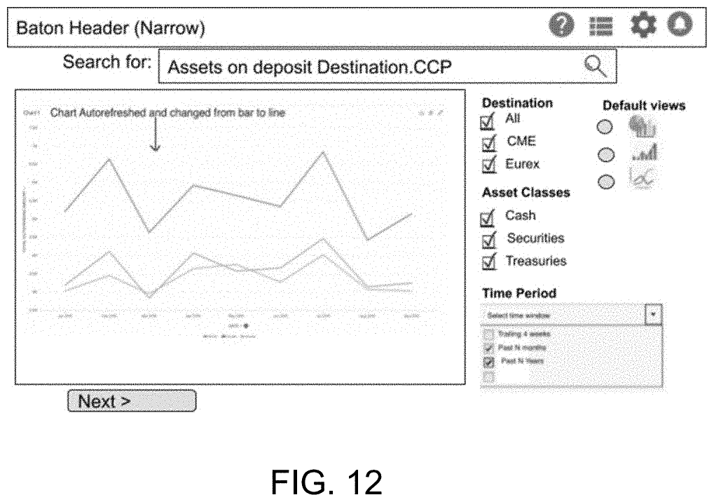

FIG. 12 illustrates another example implementation of identifying specific data and other information. For example, FIG. 12 includes an output of insight augmented with filters which can be used for more detailed analysis.

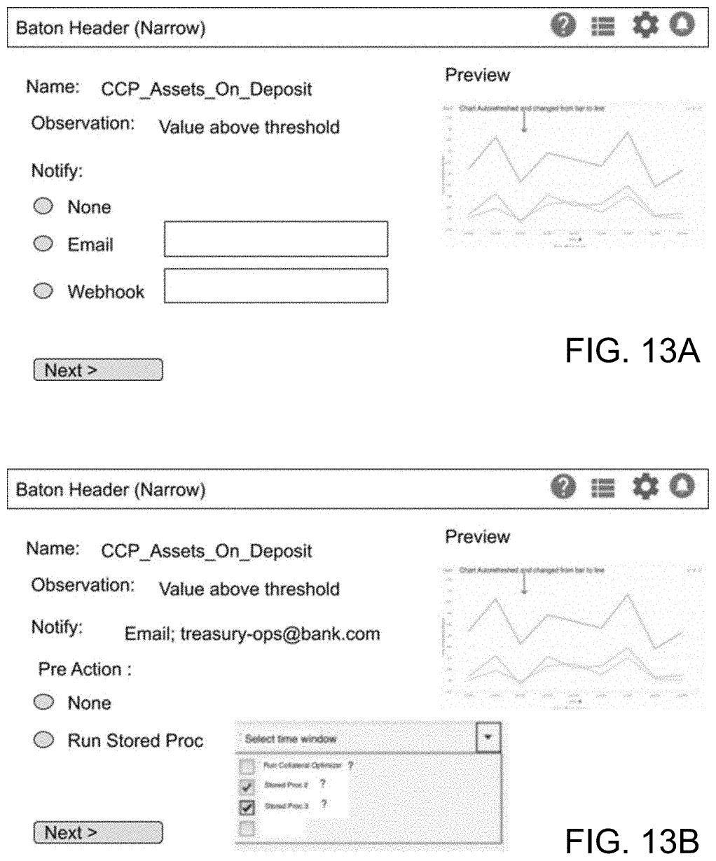

FIGS. 13A and 13B illustrate another example process of identifying specific data and other information. For example, FIGS. 13A and 13B illustrate the ability to define actions based on metrics reaching a threshold or a filter criteria. In some embodiments, the actions can range from simple notifications to more complicated logic that can trigger other events or actions.

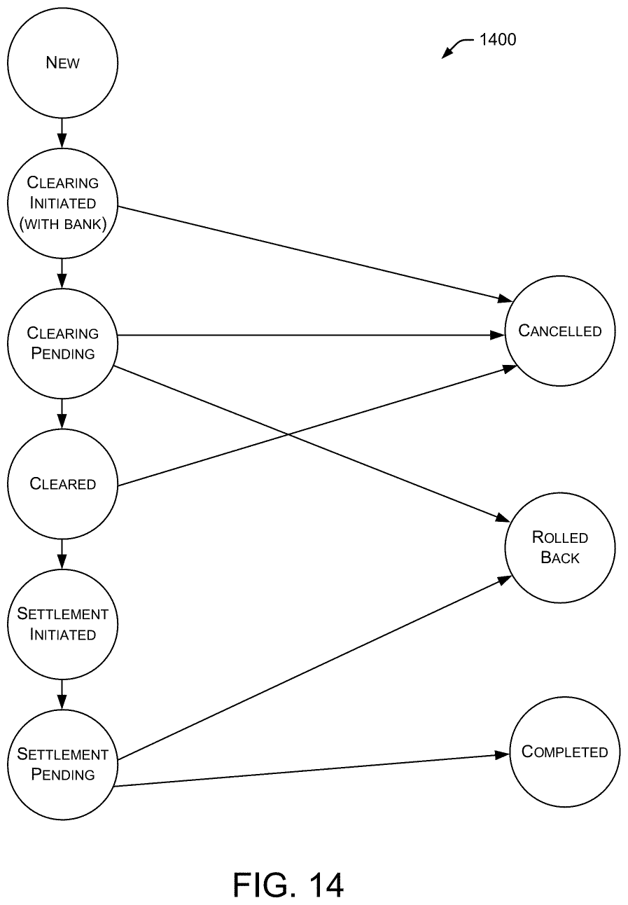

FIG. 14 illustrates an example state diagram 1400 showing various states that a transaction may pass through. As shown in FIG. 14, a particular transaction may be initiated (“new”), then clearing is initiated with a bank, after which the transaction's state is “clearing pending.” The next transaction state is “cleared”, then settlement is initiated, after which the transaction state is “settlement pending.” After the transaction has settled, the state becomes “completed.” As shown in state diagram 1400, the state diagram may branch to “cancelled” at locations in the state diagram. For example, a transaction may be cancelled due to insufficient funds, a mutual decision to reverse the transaction before settlement, a bank internal ledger failure, and the like. Additionally, the state diagram may branch to “rolled back” at multiple locations. For example, a transaction may be rolled back due to an unrecoverable error, a cancellation of the transaction, and the like.

Each transaction and the associated transaction states may have additional metadata. The shared ledger (e.g., ledger 118 in FIG. 1) man contain all the state information and state changes for a transaction. A separate record is maintained for each state of the transaction. The record is not updated or modified. In some embodiments, all transactions are final and irreversible. The metadata for the new transaction includes a reference to the erroneous transaction that needs to be reversed. The parties are informed of the request to reverse the erroneous transaction as part of a new transaction. The new transaction also goes through the state changes shown in FIG. 14. When the new transaction is completed, the metadata of the initial transaction is also updated.

In some embodiments, the transactions and the metadata recorded in the shared permissioned ledger contain information that are very sensitive and confidential to the businesses initiating the instructions. The systems and methods described herein maintain the security of this information by encrypting data for each participant using a symmetric key that is unique to the participant. In some embodiments, the keys also have a key rotation policy where the data for that node is rekeyed. The keys for each node are bifurcated and saved in a secure storage location with role-based access controls. In some embodiments, only a special service called a cryptographic service can access these keys at runtime to encrypt and decrypt the data.

FIG. 15 is a block diagram illustrating an embodiment 1500 of a financial management system 1502 interacting with a cryptographic service 1508 and multiple client nodes 1504 and 1506. Although two client nodes 1504, 1506 are shown in FIG. 15, alternate embodiments may include any number of client nodes coupled to financial management system 1502. In the embodiment of FIG. 15, financial management system 1502 communicates with client nodes 1504, 1506 to manage one or more transactions between client nodes 1504 and 1506, or between one of client nodes 1504, 1506 and other client nodes, devices, or systems (not shown). Financial management system 1502 also communicates with cryptographic service 1508, which manages secure access to a data store 1514. In some embodiments, data store 1514 is a shared ledger (e.g., ledger 118 in FIG. 1) of the type discussed herein. In these embodiments, data store 1514 represents the capabilities of the shared ledger as they relate to data permissions.

As shown in FIG. 15, data store 1514 stores encrypted data associated with client nodes 1504 and 1506. In alternate embodiments, data store 1514 may store encrypted data associated with any number of client nodes. Cryptographic service 1508 ensures security of the data in data store 1514 using, for example, secure bifurcated keys that are stored in node 1 key storage 1510 and node 2 key storage 1512. Each key is unique for the associated client node. When financial management system 1502 wants to access data from data store 1514, the data access request must include an appropriate key to ensure that the data access request is authorized.

Each transaction can have two or more participants. In addition to the multiple parties involved in the transaction, there can be one or more “observers” to the transaction. The observer status is important from a compliance and governance standpoint. For example, the Federal Reserve or the CFTC is not a participant of the transaction, but may have observer rights on certain type of transactions in the system. In some embodiments the participants can subscribe to certain types of events. The transaction state in the state diagram above changes trigger events in the described systems.

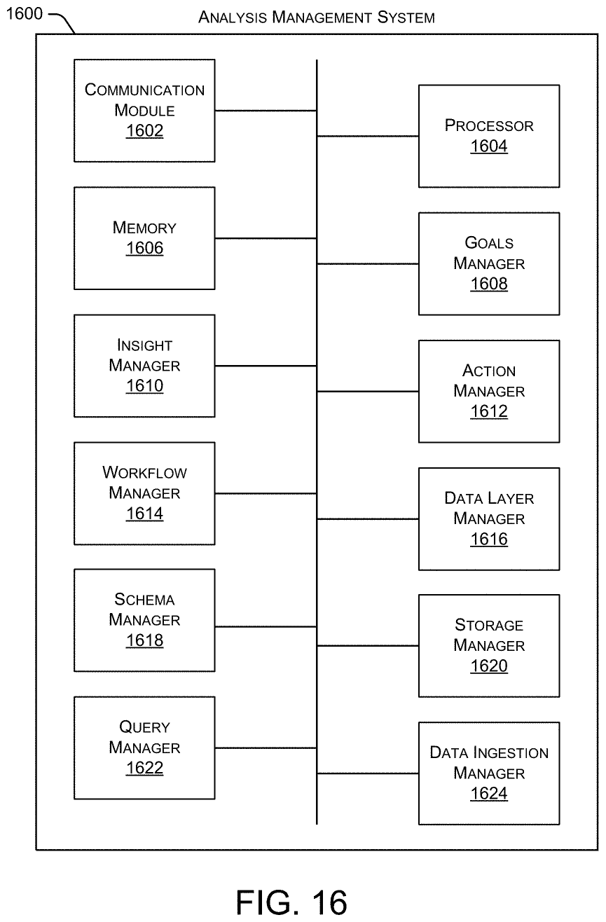

FIG. 16 illustrates an embodiment of an analysis management system 1600. In some embodiments, analysis management system 1600 is coupled to financial management system 102 or any other type of system (e.g., financial management or financial transaction processing systems). In particular implementations, analysis management system 1600 is integrated into financial management system 102. In some embodiments, analysis management system 1600 can access data store 116 and ledger 118 discussed herein.

As shown in FIG. 16, analysis management system 1600 includes a communication module 1602, a processor 1604, and a memory 1606. Communication module 1602 allows analysis management system 1600 to communicate with other systems and devices. Processor 1604 executes various instructions to implement the functionality provided by analysis management system 1600, as discussed herein. Memory 1606 stores these instructions as well as other data used by processor 1604 and other modules and components discussed herein.

A goals manager 1608 manages the definition and execution of one or more goals of the type discussed herein. An insight manager 1610 manages the identification, evaluation, and presentation of various insights, as described herein. Analysis management system 1600 also includes an action manager 1612 that oversees selection of and implementation of one or more actions to achieve a goal or other objective. A workflow manager 1614 assists with the selection and implementation of workflows to achieve particular actions, results, and the like.

Analysis management system 1600 further includes a data layer manager 1616 that manages various information and data associated with the data layer, as discussed herein. A schema manager 1618 manages the schema and associated information, as discussed herein. Analysis management system 1600 also includes a storage manager 1620 that handles storage and retrieval of various data and information of the type discussed herein. A query manager 1622 handles various operations and functions associated with user queries and related tasks. A data ingestion manager 1624 manages various data ingestion and data handling tasks, as discussed herein.

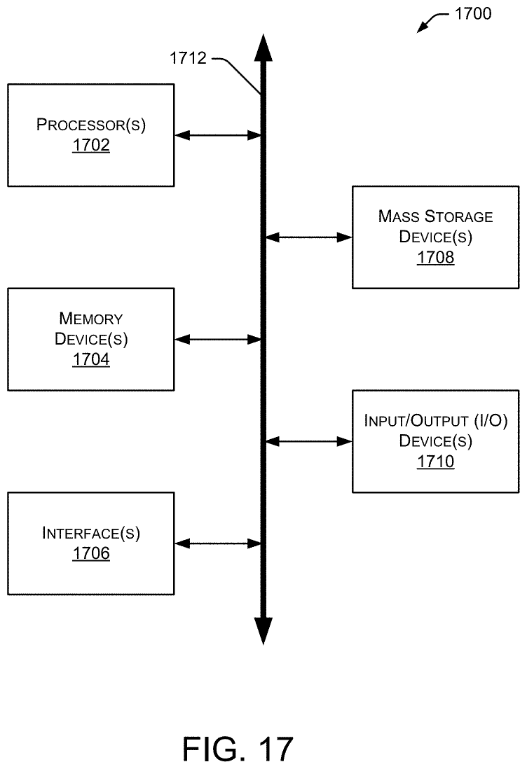

FIG. 17 is a block diagram illustrating an example computing device 1700.

Computing device 1700 may be used to perform various procedures, such as those discussed herein. Computing device 1700 can function as a server, a client, a client node, a financial management system, or any other computing entity. Computing device 1700 can be any of a wide variety of computing devices, such as a workstation, a desktop computer, a notebook computer, a server computer, a handheld computer, a tablet, a smartphone, and the like. In some embodiments, computing device 1700 represents any of the computing devices discussed herein.

Computing device 1700 includes one or more processor(s) 1702, one or more memory device(s) 1704, one or more interface(s) 1706, one or more mass storage device(s) 1708, and one or more Input/Output (I/O) device(s) 1710, all of which are coupled to a bus 1712. Processor(s) 1702 include one or more processors or controllers that execute instructions stored in memory device(s) 1704 and/or mass storage device(s) 1708. Processor(s) 1702 may also include various types of computer-readable media, such as cache memory.

Memory device(s) 1704 include various computer-readable media, such as volatile memory (e.g., random access memory (RAM)) and/or nonvolatile memory (e.g., read-only memory (ROM)). Memory device(s) 1704 may also include rewritable ROM, such as Flash memory.

Mass storage device(s) 1708 include various computer readable media, such as magnetic tapes, magnetic disks, optical disks, solid state memory (e.g., Flash memory), and so forth. Various drives may also be included in mass storage device(s) 1708 to enable reading from and/or writing to the various computer readable media. Mass storage device(s) 1708 include removable media and/or non-removable media.

I/O device(s) 1710 include various devices that allow data and/or other information to be input to or retrieved from computing device 1700. Example I/O device(s) 1710 include cursor control devices, keyboards, keypads, microphones, monitors or other display devices, speakers, printers, network interface cards, modems, lenses, CCDs or other image capture devices, and the like.

Interface(s) 1706 include various interfaces that allow computing device 1700 to interact with other systems, devices, or computing environments. Example interface(s) 1706 include any number of different network interfaces, such as interfaces to local area networks (LANs), wide area networks (WANs), wireless networks, and the Internet.

Bus 1712 allows processor(s) 1702, memory device(s) 1704, interface(s) 1706, mass storage device(s) 1708, and I/O device(s) 1710 to communicate with one another, as well as other devices or components coupled to bus 1712. Bus 1712 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 1700, and are executed by processor(s) 1702. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

In the above disclosure, reference has been made to the accompanying drawings, which form a part hereof, and in which is shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” “selected embodiments,” “certain embodiments,” etc., indicate that the embodiment or embodiments described may include a particular feature, structure, or characteristic, but every embodiment may not necessarily include the particular feature, structure, or characteristic. Additionally, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that may be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can include at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired and wireless) to a computer, the computer properly views the connection as a transmission medium. Transmissions media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions include, for example, instructions and data which, when executed at a processor, cause a general purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a module may include computer code configured to be executed in one or more processors, and may include hardware logic/electrical circuitry controlled by the computer code. These example devices are provided herein purposes of illustration, and are not intended to be limiting. Embodiments of the present disclosure may be implemented in further types of devices, as would be known to persons skilled in the relevant art(s).

At least some embodiments of the disclosure have been directed to computer program products comprising such logic (e.g., in the form of software) stored on any computer useable medium. Such software, when executed in one or more data processing devices, causes a device to operate as described herein.

While various embodiments of the present disclosure are described herein, it should be understood that they are presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the described exemplary embodiments, but should be defined only in accordance with the following claims and their equivalents. The description herein is presented for the purposes of illustration and description. It is not intended to be exhaustive or to limit the disclosure to the precise form disclosed. Many modifications and variations are possible in light of the disclosed teaching. Further, it should be noted that any or all of the alternate implementations discussed herein may be used in any combination desired to form additional hybrid implementations of the disclosure.

1. A method of accomplishing a financial goal, the method comprising:
identifying a financial goal to be achieved;
identifying financial account information associated with the financial goal;
generating a plurality of insights based on information from a plurality of data sources;
implementing a tool to generate at least one action based on the financial goal, the account information, and the insights;
generating a recommendation based on the plurality of insights and the action; and
automatically making financial account changes based on the recommendation to accomplish the financial goal.

2. The method of claim 1, wherein the financial account information includes an account balance at a first financial institution and an account balance at a second financial institution.

3. The method of claim 1, wherein the financial account information includes at least one of an asset position, an asset class, an asset type, and products being traded.

4. The method of claim 1, wherein the financial account information includes data associated with at least one of settlement instructions, margin calls, and trade positions.

5. The method of claim 1, wherein the financial account information includes data associated with at least one of a pledge, a recall, a substitution, a margin call notification, and an excess collateral notification.

6. The method of claim 1, wherein generating insights based on information from a plurality of data sources further comprises analyzing at least one of margin calls, margin call history, and excess/deficit history.

7. The method of claim 1, further comprising identifying a plurality of actions necessary to implement the recommendation.

8. The method of claim 7, wherein automatically making financial account changes based on the recommendation includes implementing the plurality of actions necessary to accomplish the recommendation.

9. The method of claim 8, further comprising generating a plurality of instructions for entities or financial institutions to implement the plurality of actions necessary to accomplish the recommendation.

10. The method of claim 7, further comprising defining at least one workflow to execute the plurality of actions.

11. The method of claim 1, wherein generating insights further comprises defining at least one financial filter associated with the financial account information.

12. An apparatus for accomplishing a financial goal, the apparatus comprising:
a communication module configured to receive a financial goal to be achieved;
a processor configured to identify financial account information associated with the financial goal;
an insight manager configured to generate a plurality of insights based on information from a plurality of data sources, the insight manager further configured to implement a tool to generate a recommendation based on the financial goal, the account information, and the plurality of insights; and
an action manager configured to automatically implement financial account changes based on the recommendation to accomplish the financial goal.

13. The apparatus of claim 12, wherein the financial account information includes an account balance at a first financial institution and an account balance at a second financial institution.

14. The apparatus of claim 12, wherein the financial account information includes at least one of an asset position, an asset class, an asset type, and products being traded.

15. The apparatus of claim 12, wherein the financial account information includes data associated with at least one of settlement instructions, margin calls, and trade positions.

16. The apparatus of claim 12, wherein the financial account information includes data associated with at least one of a pledge, a recall, a substitution, a margin call notification, and an excess collateral notification.

17. The apparatus of claim 12, wherein the action manager is further configured to identify a plurality of actions necessary to implement the recommendation.

18. The apparatus of claim 17, wherein the action manager is further configured to generate a plurality of instructions for financial institutions to implement the plurality of actions necessary to accomplish the recommendation.

19. The apparatus of claim 17, further comprising a workflow manager configured to define at least one workflow to execute the plurality of actions.

20. The apparatus of claim 12, wherein the insight manager is further configured to define at least one financial filter associated with the financial account information.
